(19) United States
(12) Patent Application Publication
(10) Pub. No.: US 2014/0352464 A1
(43) Pub. Date: Dec. 4, 2014

(54) APPARATUS FOR PROPELLING A COIL CLAD HOSE

(71) Applicant: STONEAGE, INC., Durango, CO (US)

(72) Inventor: Gerald P. Zink, Durango, CO (US)

(73) Assignee: STONEAGE, INC., Durango, CO (US)

(21) Appl. No.: 13/905,969

(22) Filed: May 30, 2013

(51) Int. Cl. F16H 19/04

(52) U.S. Cl. CPC F16H 19/04
USPC 74/30

(57) ABSTRACT

An apparatus is disclosed for propelling a coil clad hose through a passage through a housing. A first driven pair of bull gears sandwiching a rotatable drive sprocket is rotatably fixed to a first rotatable axle in the housing orthogonal to the passage. A second pair of bull gears sandwiching a second drive sprocket are all rotatably fastened to a second axle in the housing parallel to the first axle. The second pair of bull gears mesh with the first pair of spaced bull gears. Teeth on the drive sprockets engage part of the coil clad hose when the fluid hose is inserted into the passage. A slip clutch between the pairs of spaced bull gears and the drive sprocket on each of the axles adjusts frictional grip on the coil when one of the bull gears is driven to propel the hose through the passage.

### BACKGROUND OF THE DISCLOSURE

The present disclosure is directed to manipulation of flexible conduit, tubing and hoses. In particular, embodiments of the present disclosure are directed to an apparatus for extension and retraction of flexible conduit such as a helical coil clad high pressure hose.

During water blast cleaning operations in fluid conduits such as a piping system, heat exchanger tubing, or sewer systems, high pressure hoses are often difficult to manipulate over distances. Various power driven mechanisms have been developed to address such difficulties. One such mechanism is disclosed in my U.S. patent application Ser. No. 12/723,410, filed Mar. 12, 2010 and published as US Patent Publication No. 2011/0220700, the content of which is incorporated herein by reference in its entirety.

### SUMMARY OF THE DISCLOSURE

The present disclosure directly addresses such needs. An apparatus in accordance with the present disclosure for propelling a coil clad hose that includes a first driven pair of bull gears sandwiching a rotatable drive sprocket rotatably fixed to a first axle in a frame. The frame may be an open or closed protective housing. In an embodiment in which the coil clad hose passes through a passage through the frame or housing, this first axle is oriented orthogonal to and spaced from the passage through the housing. A second pair of bull gears sandwiching a second drive sprocket is rotatably fastened to a second axle parallel to the first axle in the housing. The second pair of bull gears mesh with the first pair of spaced bull gears. Both axles are aligned orthogonal to and spaced on opposite sides, and equidistant from, the passage through the housing. Teeth on the drive sprockets engage part of the coil clad fluid hose when the fluid hose is inserted into the passage. A slip clutch between the pairs of spaced bull gears and the drive sprocket on each of the axles adjusts frictional grip on the coil when one of the bull gears is driven to propel the hose through the passage. This clutch primarily limits the force transmitted through the sprocket teeth to the coil of the coil clad hose like a rack (the coil clad hose) and pinion (the sprocket) arrangement. This arrangement can also protect the coil clad hose from buckling in case of encountering an obstacle or obstruction. This arrangement also allows the two sprockets to share the load transmitted to the hose equally and thus also to be synchronized.

In one aspect, a coil clad hose feed/propelling apparatus in accordance with one embodiment of the present disclosure includes a hollow housing having a pinion drive gear rotatably supported in the housing and the housing may include a through passage for receiving and passing a coil clad portion of a tubular body therethrough. Mounted in the housing is a first pair of spaced bull gears fixed to a first axle rotatably supported in a first portion of the hollow housing and oriented orthogonal to the through passage. One of the first pair of bull gears is engaged with the pinion drive gear. Also mounted in the housing is a second pair of spaced bull gears rotatably fastened to a second axle parallel to and spaced from the first axle. This second pair of spaced bull gears meshes with the first pair of spaced bull gears. A first drive sprocket is rotatably supported on the first axle and sandwiched between the first pair of bull gears. The first axle is spaced from the passage through the housing such that the first drive sprocket can engage part of the coil clad portion of the tubular body inserted into the passage. A second drive sprocket is rotatably supported on the second axle and sandwiched between the second pair of bull gears, and the second axle is spaced from the passage through the housing such that the second drive sprocket can engage another part of the coil clad portion of the tubular body inserted into the passage. A slip clutch is provided between the pairs of spaced bull gears and the drive sprockets on each of the axles.

Preferably the housing includes a first part supporting the first axle and a second part supporting the second axle, wherein the first and second parts of the housing together define the through passage for receiving the tubular body therethrough. The slip clutch has a first pair of slip clutch discs on the first axle sandwiching the first sprocket therebetween and a second pair of slip clutch discs on the second axle sandwiching the second sprocket therebetween. Alternatively slip clutch discs may be omitted in some applications and the gear and sprocket faces utilized directly as the slip clutch. The slip clutch may include one or more wave springs between the first drive sprocket and the first bull gear. The slip clutch may include wave springs on each of the first and second axles between the first and second drive sprockets and the first and second bull gears.

The first and second drive sprockets are spaced apart by a distance corresponding to the coil clad portion of a tubular body inserted into the passage so that teeth on the sprockets engage diametrically opposite portions of the coil clad portion of the tubular body.

Another embodiment in accordance with another aspect of the present disclosure is an apparatus that includes a hollow housing having two separable parts defining a through passage between the parts of the housing for receiving therethrough a coil clad portion of a fluid hose. A first pair of spaced bull gears is rotatably fixed to a first axle rotatably supported orthogonally to and spaced from the through passage in a first part of the hollow housing. Preferably one of the first pair of bull gears is engaged with a pinion drive gear. A second pair of spaced bull gears is rotatably fastened to a second axle in the second part of the housing parallel to and spaced from the first axle and orthogonal to and spaced from the through passage. This second pair of spaced bull gears is positioned to mesh with the first pair of spaced bull gears when the separable parts of the housing are joined.

A first drive sprocket is rotatably supported on the first axle and sandwiched between the first pair of bull gears. The first axle is spaced from the passage through the housing such that the first drive sprocket can engage part of the coil clad portion of the fluid hose inserted into the passage. A second drive sprocket is rotatably supported on the second axle and sandwiched between the second pair of bull gears. The second axle is spaced from the passage through the housing such that the second drive sprocket can engage another part of the coil clad portion of the fluid hose inserted into the passage.

A drive mechanism for use with the present apparatus my include a liquid or pneumatic fluid motor or an electric motor. Such a motor preferably includes a pinion gear extending into the housing that engages one of the two first bull gears. In one embodiment the drive mechanism is supported by the housing and the pinion gear is rotatably supported in the first part of the housing.

This embodiment of the apparatus also has at least one slip clutch between the pairs of spaced bull gears and the drive sprockets on each of the axles. Preferably the first pair of bull gears are keyed to the first axle so that they rotate with the axle. The first drive sprocket is not keyed to the first axle. It is free to rotate on the first axle. Preferably the slip clutch comprises a first pair of slip clutch discs on the first axle sandwiching the first sprocket therebetween. A second pair of slip clutch discs may be provided on the second axle sandwiching the second sprocket therebetween. In one embodiment the slip clutch may include one or more wave spring between the first drive sprocket and the first bull gear. The slip clutch may also include wave springs on each of the first and second axles between the first and second drive sprockets and the first and second bull gears.

In accordance with the present disclosure an embodiment of an apparatus for propelling a hose includes a hollow housing having a through passage for receiving a coil clad portion of a fluid hose. The apparatus includes a first pair of spaced bull gears rotatably fixed to a first axle rotatably supported orthogonal to and spaced from the through passage in a first part of the hollow housing. A second pair of spaced bull gears is rotatably fastened to a second axle in a second part of the housing parallel to and spaced from the first axle and spaced from the through passage, wherein the second pair of spaced bull gears is positioned to mesh with the first pair of spaced bull gears. A first drive sprocket is rotatably supported on the first axle and sandwiched between the pair of rotatably fixed bull gears. The first axle is spaced from the passage through the housing such that the first drive sprocket can engage part of the coil clad portion of the fluid hose when the fluid hose is inserted into the passage. A second drive sprocket is rotatably supported on the second axle and sandwiched between the second pair of bull gears, wherein the second axle is spaced from the passage through the housing such that the second drive sprocket can engage another part of the coil clad portion of the fluid hose inserted into the passage. The apparatus also includes a slip clutch between the pairs of spaced bull gears and the drive sprockets on each of the axles.

Further features, advantages and characteristics of the embodiments of this disclosure will be apparent from reading the following detailed description when taken in conjunction with the drawing figures.

### DESCRIPTION OF THE DRAWINGS

FIG. 1 is an external perspective view of one exemplary embodiment of an assembled drive apparatus for linearly moving a coil clad hose in accordance with the present disclosure.

FIG. 2 is a separate exploded perspective view of the apparatus shown in FIG. 1.

FIG. 3 is a perspective view of the internals of the apparatus shown in FIG. 1 with the housing removed.

FIG. 4 is a partial perspective view of the upper driven portion of the apparatus shown in FIG. 3.

FIG. 5 is a perspective exploded view of an alternative embodiment of an apparatus in accordance with the present disclosure

### DETAILED DESCRIPTION

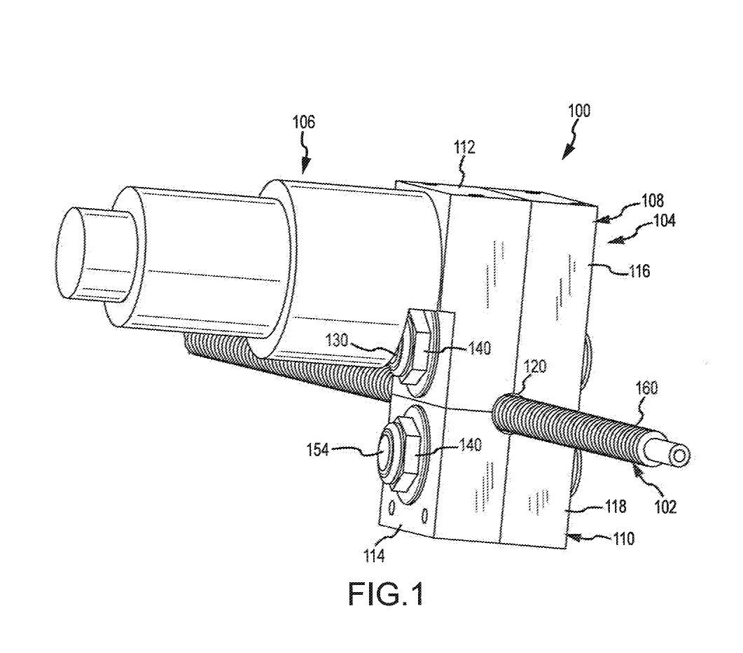

A perspective view of one exemplary embodiment of an apparatus 100 for propelling a coil clad hose 102 is shown in FIG. 1. The apparatus 100 includes a hollow two piece housing 104 to which is attached a fluid drive motor 106. In this embodiment, the housing 104 is in four pieces. Housing 104 has an upper hollow box section 108 and a lower hollow box section 110 which are vertically bolted together with threaded bolts (not shown).

Each of upper and lower box sections 108 and 110 has a left half box segment 112 and 114 and a right half box segment 116 and 118 which are bolted together by horizontal housing bolts (not shown for clarity). When assembled, the housing 104 forms a rectangular box around a central passage 120 passing through the inside four corners of the box segments 112, 114, 116, and 118.

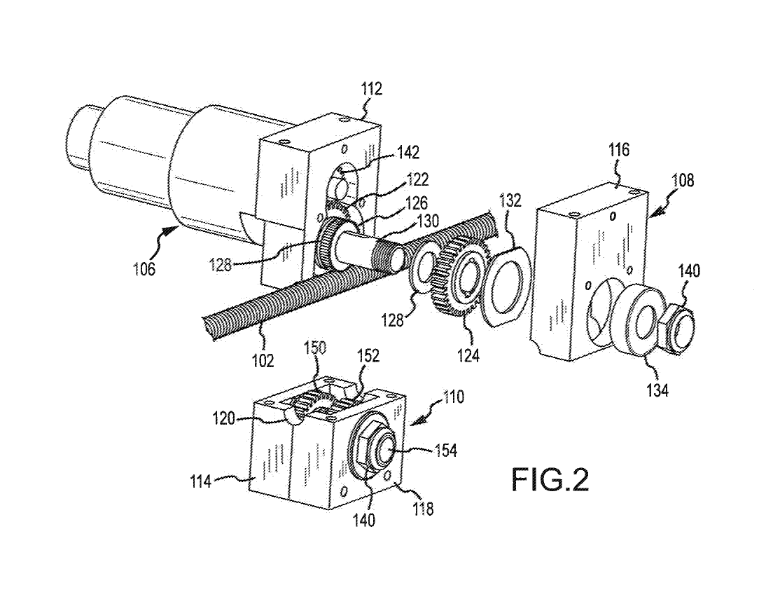

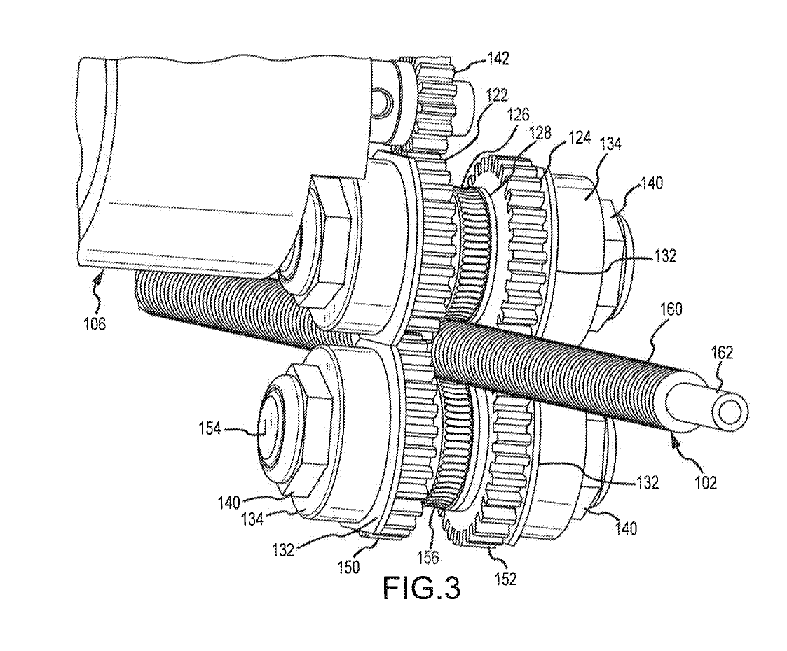

An exploded view of the apparatus 100 showing the operable internal parts of the apparatus 100 is shown in FIG. 2. An assembled perspective view of the operable internal parts of the apparatus 100 with the housing 104 removed is shown in perspective in FIG. 3.

Turning now to FIG. 2, the internal parts of the upper housing section 108 are shown in an exploded fashion. A first pair of bull gears 122 and 124 are keyed onto a first axle 130 for rotation with axle 130. These two bull gears 122 and 124 may move axially on the axle 130, but are rotatably fixed such that they rotate with the axle 130. Between these two bull gears 122 and 124 is a rotatable upper sprocket 126. Between the sprocket 126 and each of the bull gears 122 and 124 is a slip clutch disc 128. Thus the upper sprocket 126 is sandwiched between the bull gears 122 and 124 and each slip clutch disc 128 is sandwiched by the upper sprocket 126 and one of the bull gears 122 or 124. The sprocket 126 is free to rotate on the axle 130. On the other side of each of the bull gears 122 and 124 is a thrust washer 132 and a bearing 134 press/friction fit into each of the housing segment 112 or 116 that supports the axle 130 in the upper housing section 108.

The axle 130 may have a bolt head on one end or both ends may be threaded. As is shown in FIG. 1, both ends of axle 130 are threaded. Thus mounted on the axle 130, from one end to the other, is first an adjustment nut 140, a bearing 134, a thrust washer 132, a first bull gear 122, a slip clutch 128, a drive sprocket 126, a slip clutch 128, another first bull gear 124, a thrust washer 132, another bearing 134, and an adjustment nut 140.

Each of the slip clutches 128 may be a single or double friction disc set or may comprise a set of one or more wave springs depending on the friction required to transmit torque from the bull gears 122 and 124 to the freely rotatable drive sprocket 126 so that it rotates with the bull gears 122 and 124. This torque is adjusted by tightening or loosening the adjustment nuts 140 on the threaded ends of the axle 130 which squeeze the components together to increase the frictional force on the sprocket 126.

Each of the bull gears 122 and 124 has spur gear teeth that can mesh with a driven pinion gear 142 that is fastened to an end of a driven shaft from the drive motor 106. In the embodiments illustrated, the pinion gear 142 is housed within section 112 of the housing 104. It is to be understood that this pinion gear 142 could be mounted to any one of the sections 112, 114, 116 or 118.

A second set of bull gears 150 and 152 are rotatably mounted on another axle 154 in the lower housing section 110 in a similar manner except that bull gears 150 and 152 need not be rotatably fixed to the axle 154 as in the upper section 108 above described. The assembly on the lower axle 154 is best seen in FIG. 3. The assembly includes a second pair of bull gears 150 and 152 rotatably mounted on axle 154 and sandwiching a second drive sprocket 156 that is also rotatably mounted on axle 154. A set of 2 slip clutches 128 sandwich the second drive sprocket 156. Again, each of the slip clutches 128 may be made up of one or more friction discs or wave springs to provide sufficient frictional torque such that the drive sprocket rotates together with the bull gears 150 and 152 but if the torque required to drive the coil clad hose is great, the sprockets 128 and 156 can slip so as not to damage the coil clad hose being propelled through the passage 120. Again, the friction applied by the slip clutches 128 is adjusted by tightening or loosening the nuts 140 as necessary to achieve proper applied force to the coil clad hose.

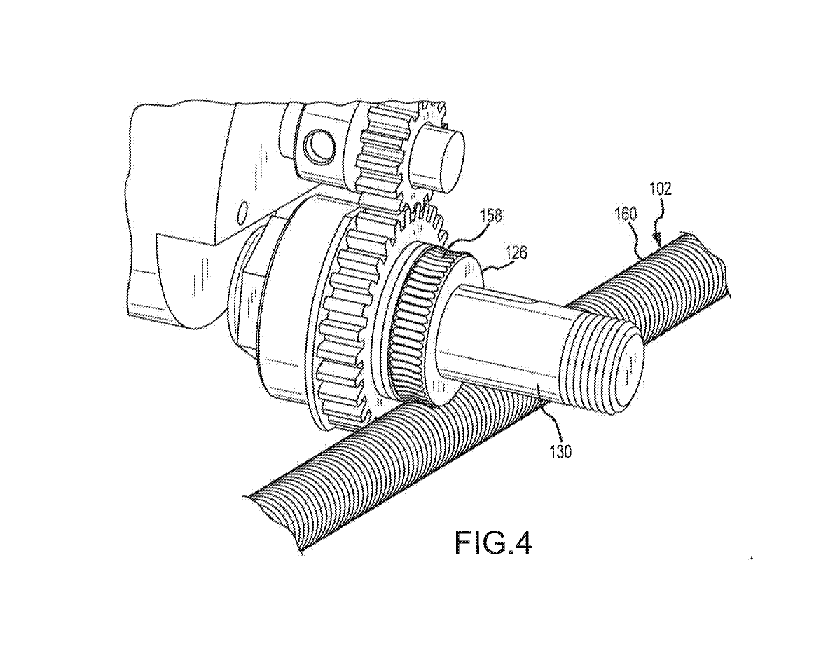

Since the coil clad hose 102 has a helical coil wrapped around the hose, the teeth 158 on each of the drive sprockets 126 and 156 are canted and hollow curved at an angle complementary to the pitch of the coil 160 wrapped around the hose 162 as is shown in FIG. 4. The curvature and cant of the teeth/grooves in the sprockets 156 and 126 match the helix of the wire coil 160. The distance between the sprockets 126 and 156 is determined by the location and spacing between the axles 130 and 154. In an embodiment having separable upper and lower housing sections 108 and 110, dimensional variations in the coil clad hose may be accommodated by spacing the sections 108 and 110 apart appropriately. Alternatively different sized housings may be provided with different passage to axle spacings provided for each different size coil clad hose.

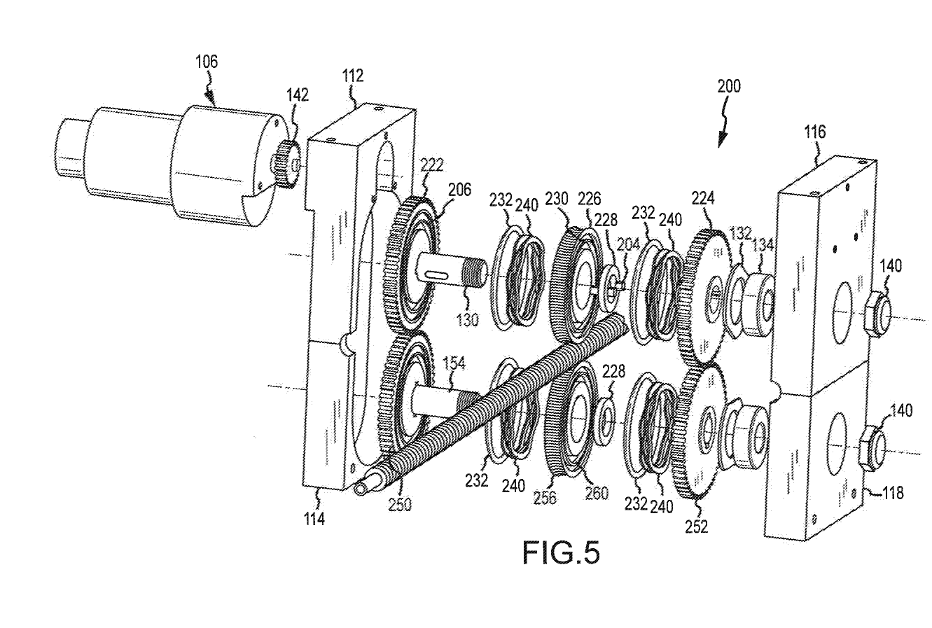

Another embodiment of an apparatus 200 is shown in the exploded view of FIG. 5. This embodiment 200 is identical to that shown in FIGS. 1-4 except for the structure of the slip clutches between the bull gears and drive sprockets. In this embodiment 200, the drive sprocket 226 is rotatably mounted on a bushing 228 which is, in turn, rotatably mounted on the upper shaft 130. The drive sprocket 226 has a circumferential groove 230 on both opposite faces of the drive sprocket 226 each for receiving an O-ring 232 therein. Each bull gear 222 and 224 rotatably fixed on the axle 130 via keys 204 has a complementary circumferential groove 206 in its inside face for receiving the O-ring 232 adjacent the drive sprocket 226. A set of wave springs 240 is sandwiched between the bull gear 222 and the sprocket 226 and bounded by the O-ring 232. Another set of wave springs 240 is sandwiched between the bull gear 224 and the sprocket 226 and bounded by the other O-ring 232. Grease is contained within the cavity formed by the sprocket 226, bushing 228, the O-rings 232 and the bull gear 222. Similarly, grease is contained within the wave spring space between the sprocket 226, bushing 228, O-ring 232 and bull gear 224.

The lower set of bull gears 250 and 252 sandwiching sprocket 256 on shaft 154 are similarly configured except that the bull gears 250 and 252 are not rotatably fixed on the axle 154. As above, the sprocket 256 is mounted on a bushing 228 and has a circumferential groove 260 on both opposite faces of the drive sprocket 256 each for receiving an O-ring 232 therein. Each bull gear 250 and 252 is rotatably mounted on the axle 154 and each has a complementary circumferential groove 206 in its inside face for receiving the O-ring 232 adjacent the drive sprocket 226. A set of wave springs 240 is sandwiched between the bull gear 250 and the sprocket 256 and bounded by the O-ring 232. Another set of wave springs 240 is sandwiched between the bull gear 252 and the sprocket 256 and bounded by the other O-ring 232. Grease is contained within the cavity formed by the sprocket 226, bushing 228, the O-rings 232 and the bull gear 250. Similarly, grease is contained within the wave spring space between the sprocket 226, bushing 228, O-ring 232 and the bull gears 252.

It is to be understood that various changes can be made to the apparatuses 100 and 200 in accordance with the present disclosure. The coil clad hose may have a helical coil pitch different than that shown in the Figures. For example, the coil clad hose may have a spaced apart pitch similar to that shown in my prior application Ser. No. 12/723,410.

For example, the housing 104 may be hinged between sections 108 and 110 so as to provide a clamshell type enclosure around a coil clad hose to be propelled. The coil clad hose may have a different spacing between the helical coil wraps than as illustrated in the figures. Thus any helix structure around a hose, cable or other conduit may be gripped by an appropriately configured drive sprocket set 126 and 156 in an alternative embodiment of the apparatus in accordance with the present disclosure.

All such changes, alternatives and equivalents in accordance with the features and benefits described herein, are within the scope of the present disclosure. Such changes and alternatives may be introduced without departing from the spirit and broad scope of my invention as defined by the claims below and their equivalents.

1. An apparatus for linearly feeding and retracting a coil clad portion of a tubular body, the apparatus comprising:
a hollow housing;
a pinion drive gear rotatably supported in the housing;
a first pair of spaced bull gears fixed to a first axle rotatably supported in a first portion of the hollow housing, wherein one of the first pair of bull gears is engaged with the pinion drive gear;
a second pair of spaced bull gears rotatably fastened to a second axle parallel to and spaced from the first axle, wherein the second pair of spaced bull gears mesh with the first pair of spaced bull gears;
a first drive sprocket rotatably supported on the first axle and sandwiched between the first pair of bull gears, such that the first drive sprocket can engage a first part of a coil clad portion of a tubular body; and
a second drive sprocket rotatably supported on the second axle and sandwiched between the second pair of bull gears, wherein the second axle is spaced from the first axle such that the second drive sprocket can engage another part of the coil clad portion of the tubular body opposite to the first part.

2. The apparatus according to claim 1 wherein the housing comprises a first part supporting the first axle and a second part supporting the second axle, the first and second parts of the housing together defining a through passage for receiving the tubular body therethrough.

3. The apparatus according to claim 1 further comprising a slip clutch comprising a first pair of slip clutch discs on the first axle sandwiching the first sprocket therebetween.

4. The apparatus according to claim 3 wherein the slip clutch comprises a second pair of slip clutch discs on the second axle sandwiching the second sprocket therebetween.

5. The apparatus according to claim 4 wherein the slip clutch comprises a wave spring between the first drive sprocket and the first bull gear.

6. The apparatus according to claim 1 wherein the slip clutch comprises wave springs on each of the first and second axles between the first and second drive sprockets and the first and second bull gears.

7. The apparatus according to claim 6 wherein the slip clutch comprises a first pair of wave springs sandwiching the first drive sprocket and a second pair of wave springs sandwiching the second drive sprocket on the second axle.

8. The apparatus according to claim 1 wherein the first and second drive sprockets are spaced apart by a distance corresponding to the coil clad portion of a tubular body inserted into the passage so as to engage diametrically opposite portions of the coil clad portion of the tubular body inserted into the passage through the housing.

9. The apparatus according to claim 2 wherein the first and second drive sprockets are spaced apart by a distance corresponding to the coil clad portion of a tubular body inserted into the passage so as to engage diametrically opposite portions of the coil clad portion of the tubular body inserted into the passage through the housing.

10. The apparatus according to claim 2 wherein first part of the housing supports a pinion gear drive mechanism.

11. An apparatus comprising:
a hollow housing having two separable parts defining a through passage between the parts of the housing for receiving therethrough a coil clad portion of a fluid hose;
a first pair of spaced bull gears rotatably fixed to a first axle rotatably supported orthogonal to and spaced from the through passage in a first part of the hollow housing;
a second pair of spaced bull gears rotatably fastened to a second axle in the second part of the housing parallel to and spaced from the first axle and spaced from the through passage, wherein the second pair of spaced bull gears are positioned to mesh with the first pair of spaced bull gears when the separable parts of the housing are joined;
a first drive sprocket rotatably supported on the first axle and sandwiched between the first pair of bull gears, wherein the first axle is spaced from the passage through the housing such that the first drive sprocket can engage part of the coil clad portion of the fluid hose inserted into the passage;
a second drive sprocket rotatably supported on the second axle and sandwiched between the second pair of bull gears, wherein the second axle is spaced from the passage through the housing such that the second drive sprocket can engage another part of the coil clad portion of the fluid hose inserted into the passage; and
a drive mechanism engaging one of the first bull gears.

12. The apparatus according to claim 11 wherein the first pair of bull gears are keyed to the first axle.

13. The apparatus according to claim 12 wherein the drive mechanism comprises a pinion gear rotatably supported in the first part of the housing.

14. The apparatus according to claim 11 further comprising a slip clutch comprising a first pair of slip clutch discs on the first axle sandwiching the first sprocket therebetween.

15. The apparatus according to claim 14 wherein the slip clutch comprises a second pair of slip clutch discs on the second axle sandwiching the second sprocket therebetween.

16. The apparatus according to claim 15 wherein the slip clutch comprises a wave spring between the first drive sprocket and the first bull gear.

17. The apparatus according to claim 14 wherein the slip clutch comprises wave springs on each of the first and second axles between the first and second drive sprockets and the first and second bull gears.

18. The apparatus according to claim 17 wherein the slip clutch comprises a first pair of wave springs sandwiching the first drive sprocket and a second pair of wave springs sandwiching the second drive sprocket on the second axle.

19. The apparatus according to claim 11 wherein the first and second drive sprockets are spaced apart by a distance corresponding to the coil clad portion of a hose inserted into the passage so as to engage diametrically opposite portions of the coil clad portion of the hose inserted into the passage through the housing.

20. An apparatus comprising:
a hollow housing having a through passage for receiving a coil clad portion of a fluid hose therethrough;
a first pair of spaced bull gears rotatably fixed to a first axle rotatably supported orthogonal to and spaced from the through passage in a first part of the hollow housing;
a second pair of spaced bull gears rotatably fastened to a second axle in a second part of the housing parallel to and spaced from the first axle and orthogonal to and spaced from the through passage, wherein the second pair of spaced bull gears is positioned to mesh with the first pair of spaced bull gears;
a first drive sprocket rotatably supported on the first axle and sandwiched between the pair of rotatably fixed bull gears, wherein the first axle is spaced from the passage through the housing such that teeth on the first drive sprocket can engage part of the coil clad portion of the fluid hose when the fluid hose is inserted into the passage;
a second drive sprocket rotatably supported on the second axle and sandwiched between the second pair of bull gears, wherein the second axle is spaced from the passage through the housing such that teeth on the second drive sprocket can engage another part of the coil clad portion of the fluid hose inserted into the passage; and
a slip clutch between the pairs of spaced bull gears and the drive sprockets on each of the axles

21. The apparatus according to claim 20 wherein the coil clad portion of the hose includes a helical coil spring wrapped around the hose and the first and second sprockets each includes complementary teeth shaped to engage diametrically opposite portions of the helical coil spring when the hose is positioned within the through passage.

22. The apparatus according to claim 20 further comprising a drive mechanism operably engaging one of the first pair of bull gears to drive the bull gears to propel the coil clad portion through the through passage.

23. The apparatus according to claim 22 wherein each axle has a threaded end passing through the housing to which an adjustment nut is fastened to regulate friction applied by the slip clutch to the first and second sprockets.

24. An apparatus comprising:
a hollow housing having a passage therethrough for receiving a coil clad hose therein;
a first driven pair of rotatably fixed bull gears sandwiching a rotatable first drive sprocket rotatably fastened to a first axle in the housing orthogonal to the passage, the first drive sprocket having teeth engageable with a portion of a coil of the coil clad hose;
a second pair of bull gears sandwiching a second drive sprocket having teeth engagable with another portion of the coil of the coil clad hose, all rotatably fastened to a second axle in the housing parallel to the first axle, wherein the second pair of bull gears mesh with the first pair of spaced bull gears; and
a slip clutch between the pairs of spaced bull gears and the first and second drive sprockets operable to adjust frictional grip of the drive sprocket teeth on the coil of the coil clad hose in the passage.
